(19) United States
(12) Patent Application Publication
(10) Pub. No.: US 2024/0340132 A1
(43) Pub. Date: Oct. 10, 2024

(54) PHYSICAL DOWNLINK SHARED CHANNEL ANTENNA PORTS INDICATION ENHANCEMENT FOR DEMODULATION REFERENCE SIGNAL TYPE 2 WITH FREQUENCY DOMAIN ORTHOGONAL COVER CODE LENGTH FOUR

(71) Applicant: APPLE INC., Cupertino, CA (US)

(72) Inventors: Haitong Sun, Cupertino, CA (US); Wei Zeng, Saratoga, CA (US); Jie Cui, San Jose, CA (US); Ankit Bhamri, Bad Nauheim (DE); Dawei Zhang, Saratoga, CA (US); Hong He, San Jose, CA (US)

(21) Appl. No.: 18/625,521

(22) Filed: Apr. 3, 2024

Related U.S. Application Data
(60) Provisional application No. 63/494,052, filed on Apr. 4, 2023.

(51) Int. Cl. H04L 5/00; H04J 13/00; H04J 13/12; H04W 72/1273

(52) U.S. Cl. CPC H04L 5/0048; H04J 13/0048; H04J 13/12; H04W 72/1273

(57) ABSTRACT

Enhancements for a physical downlink shared channel (PDSCH) antenna ports indications for demodulation reference signal (DMRS) Type 2 with frequency domain orthogonal cover code length 4 are disclosed herein. Various embodiments herein relate the use of additional and/or replacement DMRS ports (e.g., for PDSCH) in an enhanced wireless communication system as compared to DMRS ports that may be used in legacy wireless communication systems. Various applicable scenarios are discussed. Various mechanisms for determining the additional and/or replacement DMRS ports with respect to the various discussed circumstances are also discussed.

### TECHNICAL FIELD

This application relates generally to wireless communication systems, including wireless communication systems using physical downlink shared channel (PDSCH) antenna ports indications.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a table relating an FD-OCC arrangement that corresponds to a Walsh Matrix (Hadamard code) that may be used in some wireless communication systems.

FIG. 2 illustrates a table 200 relating an FD-OCC arrangement that corresponds to a cyclic shift with {0, π, π/2, 3π/2} that may be used in some wireless communication systems.

FIG. 3 illustrates a table 300 relating an FD-OCC arrangement that may be used in some wireless communication systems.

FIG. 4 illustrates a table relating DMRS ports for a PUSCH (or a PDSCH) that may be used for an eType 1 DMRS in some wireless communications systems.

FIG. 5 illustrates a table relating DMRS ports for a PUSCH (or a PDSCH) that are used for an eType 2 DMRS in some wireless communications systems.

FIG. 6 illustrates a table summarizing DMRS port mapping details for both legacy and enhanced DMRSs according to DMRS types, as may be used in some wireless communication systems.

FIG. 7 illustrates a table having entries that may be used in the case of DMRS configuration Type 2 (dmrs-Type=2) and a maximum of one symbol per DMRS location (maxLength=1) and the use of one codeword, according to embodiments herein.

FIG. 8 illustrates a table having entries that may be used in the case of DMRS configuration Type 2 (dmrs-Type=2) and a maximum of one symbol per DMRS location (maxLength=1) and the use of two codewords, according to embodiments herein.

FIG. 9 illustrates a table having entries that may be used in the case of DMRS configuration Type 2 (dmrs-Type=2) and a maximum of one symbol per DMRS location (maxLength=1) and where less than or equal to four layers are used, according to embodiments herein.

FIG. 10 illustrates a table having entries that may be used in the case of DMRS configuration Type 2 (dmrs-Type=2) and a maximum of one symbol per DMRS location (maxLength=1) and where a seven and/or eight layer PDSCH is supported, according to embodiments herein.

FIG. 11 illustrates a table having entries that may be used in the case of DMRS configuration Type 2 (dmrs-Type=2) and a maximum of one symbol per DMRS location (maxLength=1) and where there are two code division multiplexing (CDM) groups and a five, six, seven, and/or eight layer PDSCH is supported, according to embodiments herein.

FIG. 12 illustrates a table having entries that may be used in the case of DMRS configuration Type 2 (dmrs-Type=2) and a maximum of one symbol per DMRS location (maxLength=1) and where MU-MIMO is used, according to embodiments herein.

FIG. 13 illustrates a table having entries that may be used in the case of DMRS configuration Type 2 (dmrs-Type=2) and a maximum of one symbol per DMRS location (maxLength=1) and corresponding to an {0, 2, 3} antenna ports indication, according to embodiments herein.

FIG. 14A and FIG. 14B together illustrate a table having entries that may be used in the case of DMRS configuration Type 2 (dmrs-Type=2) and a maximum of two symbols per DMRS location (maxLength=2) and where a number of front-load symbols is two, according to embodiments herein. Note that in the table 1400, entries for both the use of one codeword and the use of two codewords are included.

FIG. 15 illustrates a table having entries that may be used in the case of DMRS configuration Type 2 (dmrs-Type=2) and a maximum of two symbols per DMRS location (maxLength=2), according to embodiments herein.

FIG. 16 illustrates a table having entries that may be used in the case of DMRS configuration Type 2 (dmrs-Type=2) and a maximum of two symbols per DMRS location (maxLength=2) and where one CDM group and two front load symbols are used in order to support the use of more than four layers, according to embodiments herein.

FIG. 17 illustrates a table having entries that may be used in the case of DMRS configuration Type 2 (dmrs-Type=2) and a maximum of two symbols per DMRS location (maxLength=2) and where two CDM groups and one front load symbol are used in order to support the use of more than four layers, according to embodiments herein.

FIG. 18 illustrates a table having entries that may be used in the case of DMRS configuration Type 2 (dmrs-Type=2) and a maximum of two symbols per DMRS location (maxLength=2) and where three CDM groups and one front load symbol are used in order to support the use of more than six layers, according to embodiments herein.

FIG. 19 illustrates a table having entries that may be used in the case of DMRS configuration Type 2 (dmrs-Type=2) and a maximum of two symbols per DMRS location (maxLength=2) and corresponding to an {0, 2, 3} antenna ports indication, according to embodiments herein.

FIG. 20 illustrates an example signal flow diagram for determining DMRS ports in accordance with some embodiments.

FIG. 21 illustrates a method 2100 in accordance with one embodiment.

FIG. 22 illustrates a method 2200 in accordance with one embodiment.

FIG. 23 illustrates an example architecture of a wireless communication system, according to embodiments disclosed herein.

FIG. 24 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In some current wireless communication systems (e.g., current NR systems), for physical downlink shared channel (PDSCH) operation, a maximum eight layers for the PDSCH is supported. An indication of which demodulation reference signal (DMRS) ports are used for the scheduled PDSCH may be indicated by an “antenna port(s)” field in a scheduling/activation downlink control information (DCI).

For NR systems, various tables relating such PDSCH DMRS port indications may be specified. For example, see the following tables in 3GPP Technical Specification (TS) 38.212, version 17.5.0 (March 2023):
Table 7.3.1.2.2-1, which is used in cases of DMRS configuration Type 1 and a maximum of one DMRS symbol;
Table 7.3.1.2.2-1A, which is a slight modification of Table 7.3.1.2.2-1 (adding {0, 2, 3} for single DCI (sDCI) spatial division multiplexed (SDMed) multiple transmission reception point (TRP) (mTRP) cases;
Table 7.3.1.2.2-2, which is used for DMRS configuration Type 1 and a maximum of 2 DMRS symbols;
Table 7.3.1.2.2-2A, which is a slight modification of Table 7.3.1.2.2-2 (adding {0, 2, 3}) for sDCI SDM mTRP cases;
Table 7.3.1.2.2-3, which is used for DMRS configuration Type 2 and a maximum of 1 DMRS symbol;
Table 7.3.1.2.2-3A, which is a slight modification of Table 7.3.1.2.2-3 (adding {0, 2, 3}) for sDCI SDM mTRP cases;
Table 7.3.1.2.2-4, which is used for DMRS configuration Type 2 and a maximum of 2 DMRS symbols; and
Table 7.3.1.2.2-4A, which is a slight modification of Table 7.3.1.2.2-4 (adding {0, 2, 3}) for sDCI SDM mTRP cases.

Some NR wireless communication systems may support a DMRS enhancement by using frequency domain orthogonal cover code (FD-OCC) length 4 to double the amount of DMRSs that may be supported over cases where FD-OCC length 2 is instead used. Under such circumstances, for DMRS configuration Type 1 and a maximum of one DMRS symbol, an enhanced DMRS may support up to eight ports where previously only four ports were supported. Further, for DMRS configuration Type 1 and a maximum of two DMRS symbols, an enhanced DMRS may support up to 16 ports where previously only up to eight ports was supported. Still further, for DMRS configuration Type 2 and a maximum of one DMRS symbol, and enhanced DMRS may support up to 12 ports, where previously only up to six ports were supported. Still further, for DMRS configuration Type 2 and a maximum of two DMRS symbols, an enhanced DMRS may support up to 24 ports, where previously only up to 12 ports were supported.

Embodiments provided herein describe PDSCH antenna ports indication enhancements for an enhanced DMRS with a FD-OCC length 4. Applicable cases include cases of DMRS configuration Type 2 and a maximum of one DMRS symbol, and cases of DMRS configuration Type 2 and a maximum of two DMRS symbols.

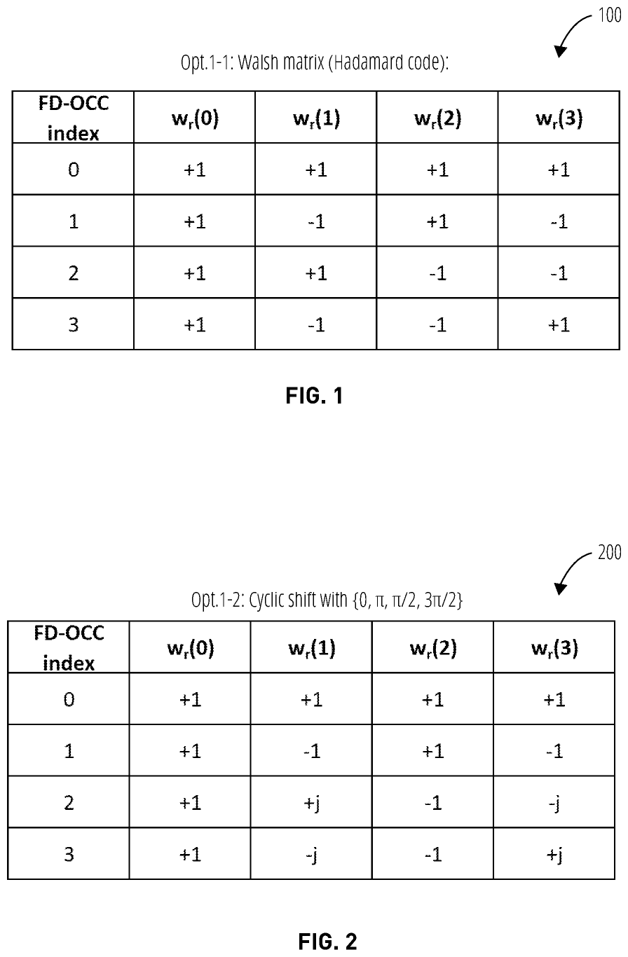

DMRS enhancements as discussed herein may use various DMRS patterns and various DMRS port to DMRS pattern mappings. Some wireless communication systems (for example, some NR systems), for FD-OCC length 4 for DMRS of PDSCH/physical uplink control channel (PUSCH) eType 1/eType 2 DMRS, support one from FD-OCCs as provided in FIG. 1 and FIG. 2.

FIG. 1 illustrates a table 100 relating an FD-OCC arrangement that corresponds to a Walsh Matrix (Hadamard code) that may be used in some wireless communication systems. Specifically table 100 may be used for PDSCH. The Walsh Matrix is characterized by its orthogonal properties, where rows or columns of the matrix can serve as orthogonal codes. When employed in FD-OCC with a length of 4, this method provides a structured approach to distribute reference signals across the frequency domain for DMRS purposes. FD-OCC length 4 for DMRS for PDSCH may support the illustrated FD-OCC in table 100.

FIG. 2 illustrates a table 200 relating an FD-OCC arrangement that corresponds to a cyclic shift with {0, π, π/2, 3π/2} that may be used in some wireless communication systems. The table 200 may be used for DMRS purposes for PUSCH. FD-OCC length 4 for DMRS for PUSCH may support the illustrated FD-OCC in table 200.

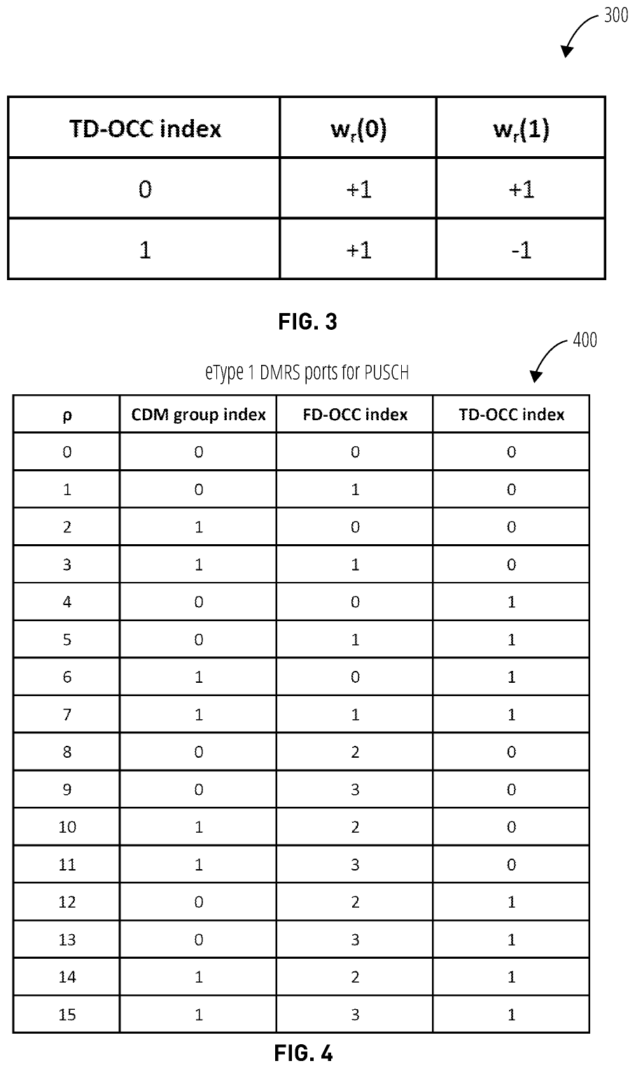

Some wireless communication systems (for example, some NR systems), for length 2 time domain orthogonal cover code (TD-OCC) (across consecutive DMRS symbols, if any) for DMRS of PDSCH/PUSCH for eType1/2 DMRS, support an FD-OCC as provided in table 300 of FIG. 3.

FIG. 4 illustrates a table 400 relating DMRS ports for a PUSCH (or a PDSCH) that may be used for an eType 1 DMRS in some wireless communications systems.

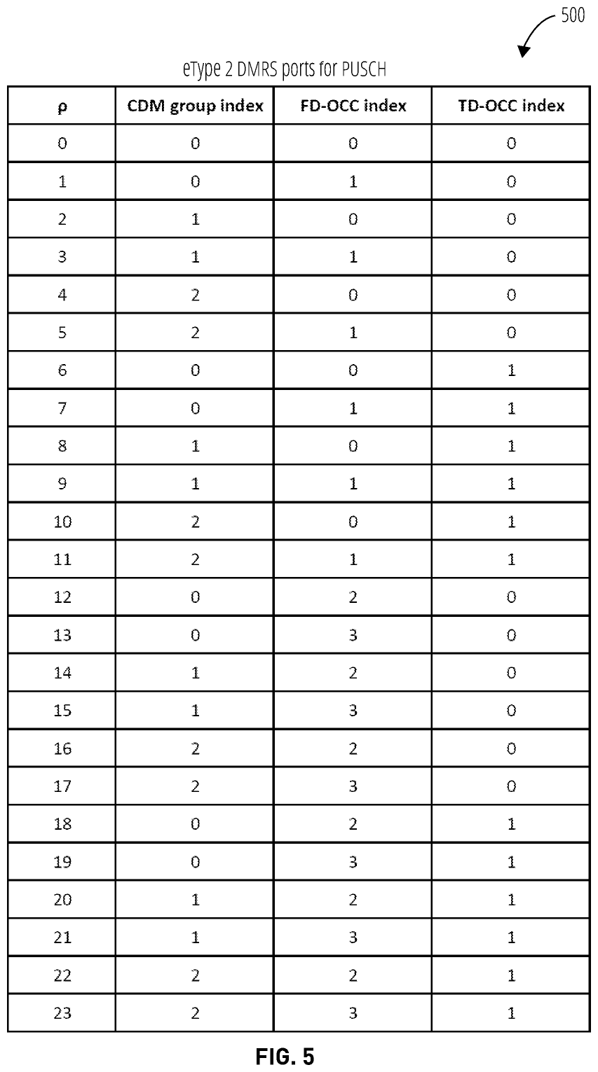

FIG. 5 illustrates a table 500 relating DMRS ports for a PUSCH (or a PDSCH) that are used for an eType 2 DMRS in some wireless communications systems.

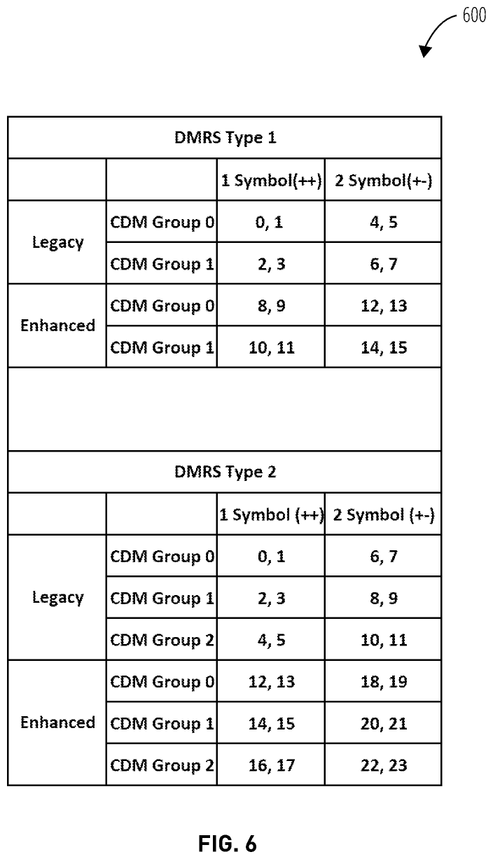

FIG. 6 illustrates a table 600 summarizing DMRS port mapping details for both legacy and enhanced DMRSs according to DMRS types, as may be used in some wireless communication systems. As shown, for DMRS type 1, legacy may support 8 ports (ports 0-7), and an additional eight ports (8-15) may be considered enhanced. For DMRS type 1, the legacy ports are grouped into two CDM groups, and the enhanced ports are grouped into two CDM groups. Similarly, for DMRS type 2, legacy may support 12 ports (ports 0-11), and an additional 12 ports (12-23) may be considered enhanced. For DMRS type 2, the legacy ports are grouped into three CDM groups, and the enhanced ports are grouped into three CDM groups.

To create the legacy CDM groups for DMRS Type 1, symbols are repeated across the allocated resource blocks. This repetition is designed to reinforce the signal, making it more robust against noise and interference, thus improving the accuracy of channel estimation.

The enhanced approach builds on the legacy method by not only repeating symbols across resource blocks but also selectively flipping the sign of certain symbols according to a predefined pattern. This technique aims to improve the orthogonality between signals from different antennas or users, further mitigating interference and enhancing channel estimation quality.

With the additional ports introduced by the enhanced DMRS, there is a need to provide a way that the network node can inform UEs of which ports to use. By assigning different ports to different UEs, the network node can more effectively schedule multiple UEs. For example, a network node may schedule a first UE on two layers and a second UE on two layers. The network node may assign ports 0 and 1 to the first UE and ports 2 and 3 to the second UE.

With the additional ports available due to the DMRS design, even more UEs may be assigned to different ports. The additional ports may allow increased flexibility and capacity to allow a network node to schedule orthogonal resources for UEs. Embodiments herein provide a framework to use the enhanced DMRS design. Directly transmitting the ports may generate a significant amount of overhead. The framework herein provides a series of tables that incorporate the new ports in a series of configurations that may be determined by the UE using the table based on available DMRS information signaled from the network node. The tables provide a way for the network node and UE to effectively use a combination of new and legacy ports.

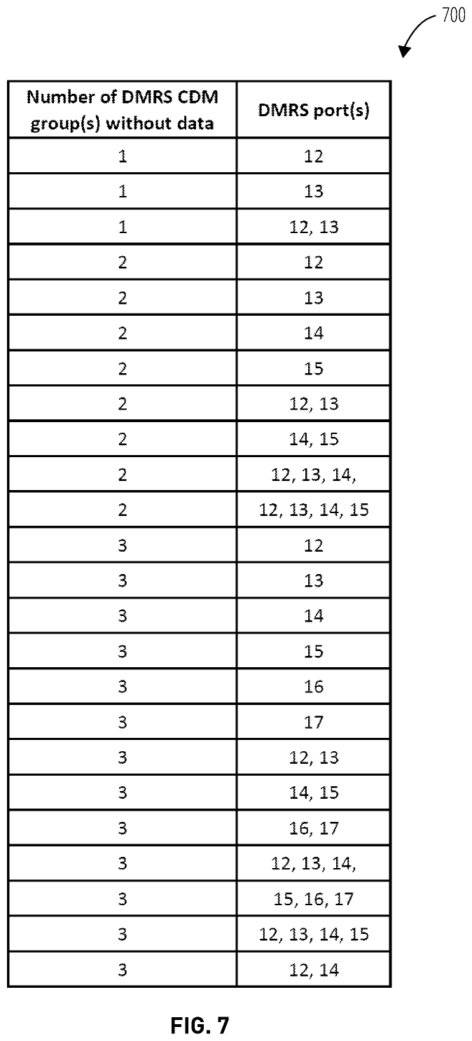

FIGS. 7-19 are examples of designs of DMRS tables for supporting legacy and enhanced ports. The DMRS tables may be used by a UE to identify ports to receive DMRS from the network node based on a DMRS configuration. The DMRS configuration may be sent by the network node and include items such as DMRS type, DMRS length, FD-OCC length, whether the DMRS is enhanced or legacy, etc. This information may be used by the UE to identify a table. The network node may also provide the UE with DMRS information such as an index (e.g., antenna ports indication) identifying a row of the DMRS table identified based on the DMRS configuration. The row of the DMRS table may include one or more DMRS ports to be used for the DMRS.

In some cases, for an enhanced DMRS, with DMRS configuration Type 2 (dmrs-Type=2) and a maximum of one symbol per DMRS location (maxLength=1), additional antenna port(s) may be specified. For example, with respect to an existing table for antenna port(s) as specified in NR systems in TS 38.212, Table 7.3.1.2.2-3, new entries may be added by adding the value 12 to the existing entries for DMRS port(s).

FIG. 7 illustrates a table 700 having entries that may be used in the case of DMRS configuration Type 2 (dmrs-Type=2) and a maximum of one symbol per DMRS location (maxLength=1) and the use of one codeword, according to embodiments herein. The table 700 may be used for enhanced DMRS by UEs with the capability to use the new ports 12-23 for DMRS type 2. Legacy devices may use the legacy table in TS 38.212, Table 7.3.1.2.2-3 to determine DMRS ports between 0-11.

As shown, DMRS ports for maxLength=1 may vary based on the number of DMRS CDM group(s) without data. In the illustrated embodiment, if the number of DMRS CDM group(s) without data is one, DMRS port(s) that may be used are 12, 13, or a combination of 12 and 13. In the illustrated embodiment, if the number of DMRS CDM group(s) without data is two, DMRS port(s) that may be used are 12; 13; 14; 15; a combination of 12 and 13; a combination of 14 and 15; a combination of 12, 13, and 14; or a combination of 12, 13, 14 and 15. In the illustrated embodiment, if the number of DMRS CDM group(s) without data is three, DMRS port(s) that may be used are 12; 13; 14; 15; 16; 17; a combination of 12 and 13; a combination of 14 and 15; a combination of 15 and 16; a combination of 12, 13, and 14; a combination of 15, 16, and 17; a combination of 12, 13, 14 and 15; or a combination of ports 12 and 14. The network node may identify which of these ports to use by sending an indication indicating the row of the table 700 the UE is to use.

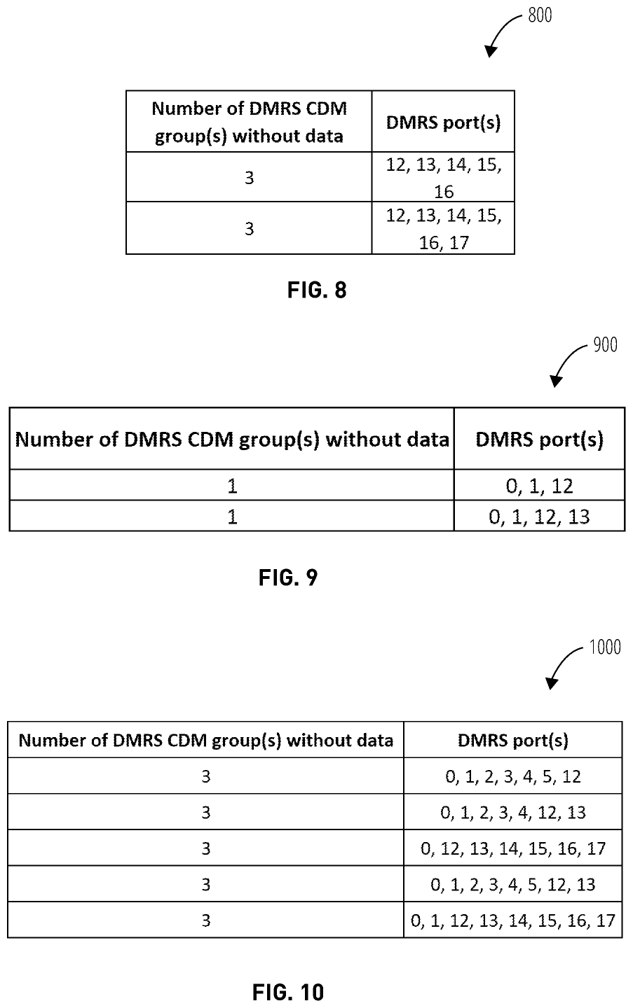

FIG. 8 illustrates a table 800 having entries that may be used in the case of DMRS configuration Type 2 (dmrs-Type=2) and a maximum of one symbol per DMRS location (maxLength=1) and the use of two codewords, according to embodiments herein. If the DMRS configuration is consistent with these parameters, the UE may use table 800 to determine the DMRS ports.

In some cases, for an enhanced DMRS, with DMRS configuration Type 2 (dmrs-Type=2) and a maximum of one symbol per DMRS location (maxLength=1), for cases of less than or equal to four layers, antenna ports may use mixed legacy and enhanced DMRS ports. For example, FIG. 9 illustrates a table 900 having entries that may be used in the case of DMRS configuration Type 2 (dmrs-Type=2) and a maximum of one symbol per DMRS location (maxLength=1) and where less than or equal to four layers are used, according to embodiments herein.

As shown, the DMRS antenna ports for both rows include a mixture of legacy ports (e.g., ports 0 and 1) and enhanced DMRS ports (ports 12 and 13). The network node may direct the UE to use either the combination of DMRS ports 0, 1, and 12, or the combination of DMRS ports 0, 1, 12, and 13. The UE may use table 900 to determine the DMRS ports.

In some cases, for an enhanced DMRS, with DMRS configuration Type 2 (dmrs-Type=2) and a maximum of symbol per DMRS location (maxLength=1), for 3 CDM groups, seven and/or eight layer PDSCH may be supported. For example, FIG. 10 illustrates a table 1000 having entries that may be used in the case of DMRS configuration Type 2 (dmrs-Type=2) and a maximum of one symbol per DMRS location (maxLength=1), for 3 CDM groups, and where a seven and/or eight layer PDSCH is supported, according to embodiments herein. The UE may use table 1000 to determine the DMRS ports.

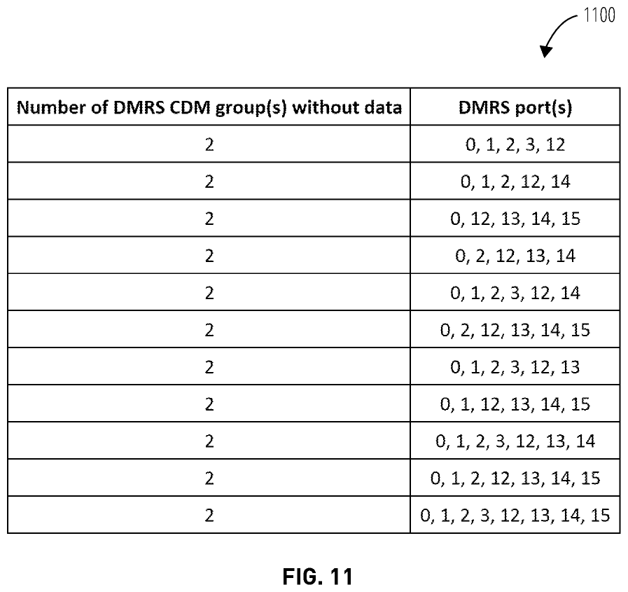

In some cases, for an enhanced DMRS, with DMRS configuration Type 2 (dmrs-Type=2) and a maximum of one symbol per DMRS location (maxLength=1), for cases where there are two CDM groups, a five, six, seven, and/or eight layer PDSCH may be supported. For example, FIG. 11 illustrates a table 1100 having entries that may be used in the case of DMRS configuration Type 2 (dmrs-Type=2) and a maximum of one symbol per DMRS location (maxLength=1) and where there are two CDM groups and a five, six, seven, and/or eight layer PDSCH is supported, according to embodiments herein.

The UE may use table 1100 to determine the DMRS ports. As shown, in some embodiments, the table 1100 may include groups of DMRS port(s) that include both legacy ports and enhanced ports. For example, the DMRS ports may be the combination of ports 0, 1, 2, 3, and 12; the combination of ports 0, 1, 2, 3, 12, and 14; the combination of ports 0, 1, 2, 3, 12, 13 and 14; the combination of ports 0, 1, 2, 3, 12, 13, 14, and 15 among other combinations based on an indication from the network node.

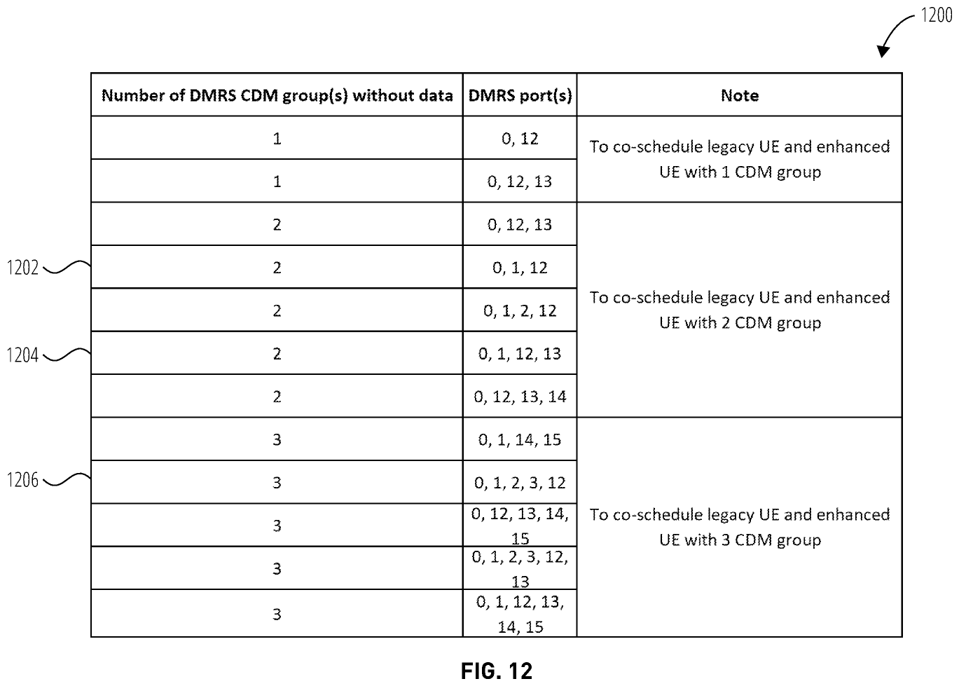

In some cases, for an enhanced DMRS, with DMRS configuration Type 2 (dmrs-Type=2) and a maximum of one symbol per DMRS location (maxLength=1), additional ports may be specified. For example, with respect to an existing table for antenna port(s) as specified in NR systems in TS 38.212 Table 7.3.1.2.2-3, new entries may be added to facilitate multiple user multiple input multiple output (MIMO) (MU-MIMO) scheduling. For instance, FIG. 12 illustrates a table 1200 having entries that may be used in the case of DMRS configuration Type 2 (dmrs-Type=2) and a maximum of one symbol per DMRS location (maxLength=1) and where MU-MIMO is used, according to embodiments herein.

The UE may use table 1200 to determine the DMRS ports. As shown, in some embodiments, the table 1200 may include groups of DMRS port(s) that include both legacy ports and enhanced ports. For example, in some embodiments, when the number of DMRS CDM groups without data is two, the network node may indicate to the UE either ports 0, 1, and 12 (e.g., row 1202); or ports 0, 1, 12, and 13 (e.g., row 1204). One option when the number of DMRS CDM groups without data is three is that the network node may indicate to the UE ports 0, 1, 2, 3, and 12 (e.g., row 1206). The row of the table 1200 may be based on the number of DMRS CDM groups without data and an indication from the network node.

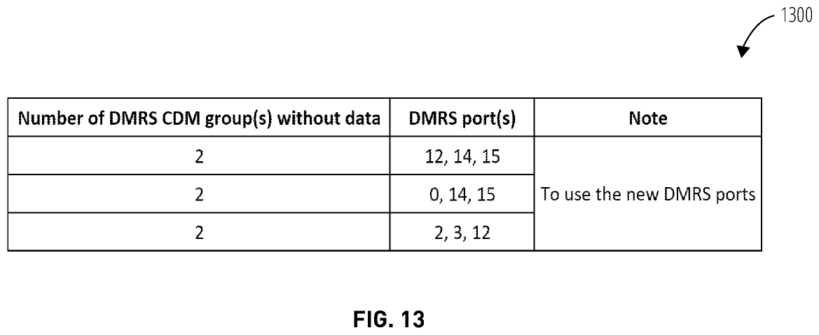

In some cases, for enhanced DMRS, with DMRS configuration Type 2 (dmrs-Type=2) and a maximum of one symbol per DMRS location (maxLength=1), for cases corresponding to an {0, 2, 3} antenna ports indication, additional ports may be specified. For example, with respect to an existing table for antenna port(s) in such cases as specified in NR systems in TS 38.212, Table 7.3.1.2.2-3A, new entries may be added to facilitate the use of new ports in such cases. For example, FIG. 13 illustrates a table 1300 having entries that may be used in the case of DMRS configuration Type 2 (dmrs-Type=2) and a maximum of one symbol per DMRS location (maxLength=1) and corresponding to an {0, 2, 3} antenna ports indication, according to embodiments herein.

In some cases, for enhanced DMRS, for DMRS configuration Type 2 (dmrs-Type=2) and a maximum of two symbols per DMRS location (maxLength=2), for cases corresponding to the use of two front-load symbols, additional ports may be specified. For example, with respect to an existing table for antenna port(s) in such cases as specified in NR systems in TS 38.212, Table 7.3.1.2.2-4, new entries may be added to facilitate the use of new ports in such cases. The new entries may be generated by, for example, adding the value 12 to the existing entries for DMRS port(s).

Note that when the number of front-loaded symbols is instead one, it may be that one or more proposals for the case of DMRS configuration Type 2 (dmrs-Type=2) and a maximum of one symbol per DMRS location (maxLength=1) as discussed herein is instead used.

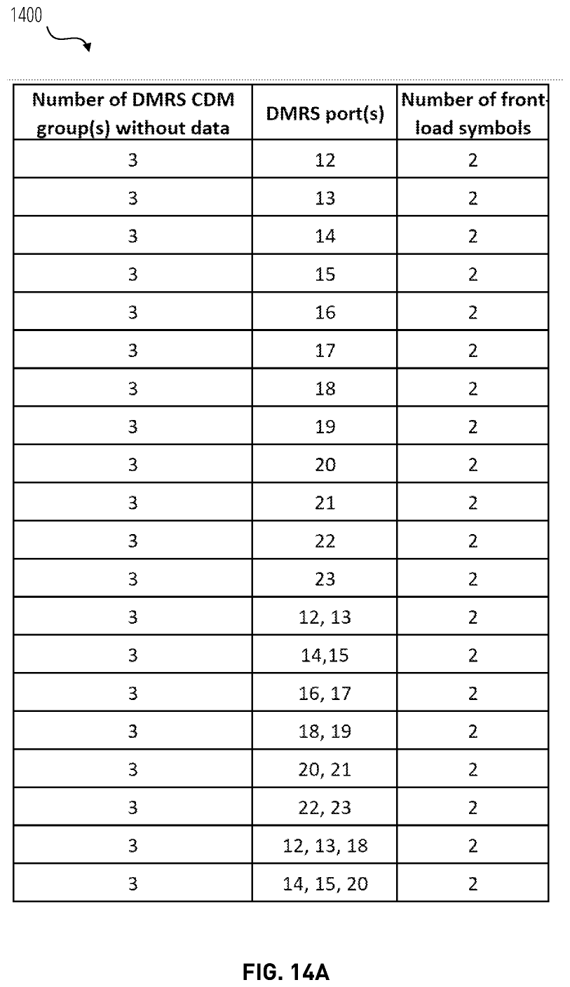

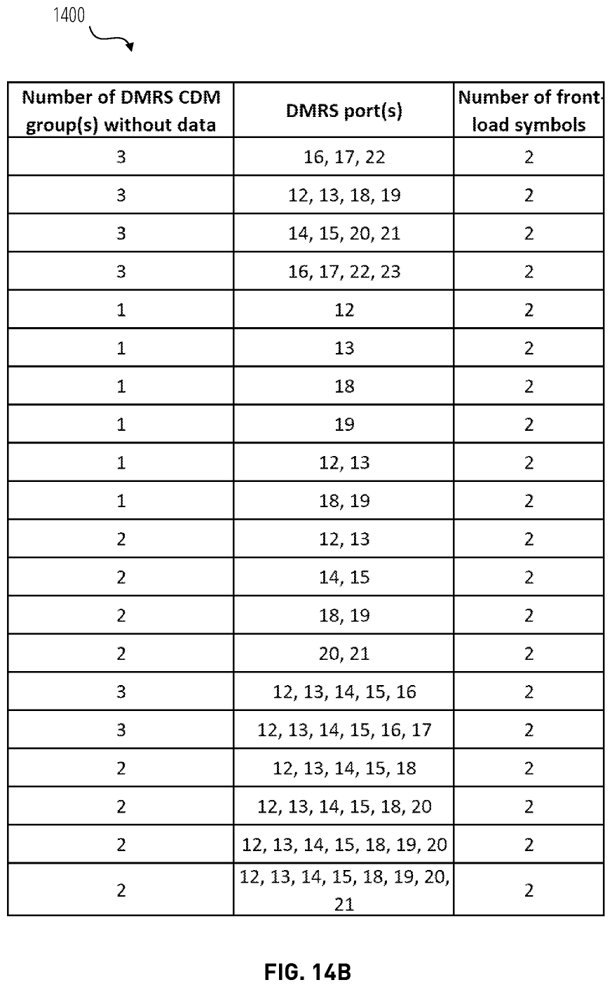

FIG. 14A and FIG. 14B together illustrate a table 1400 having entries that may be used in the case of DMRS configuration Type 2 (dmrs-Type=2) and a maximum of two symbols per DMRS location (maxLength=2) and where a number of front-load symbols is two, according to embodiments herein. Note that in the table 1400, entries for both the use of one codeword and the use of two codewords are included. The UE may use table 1400 to determine the DMRS ports.

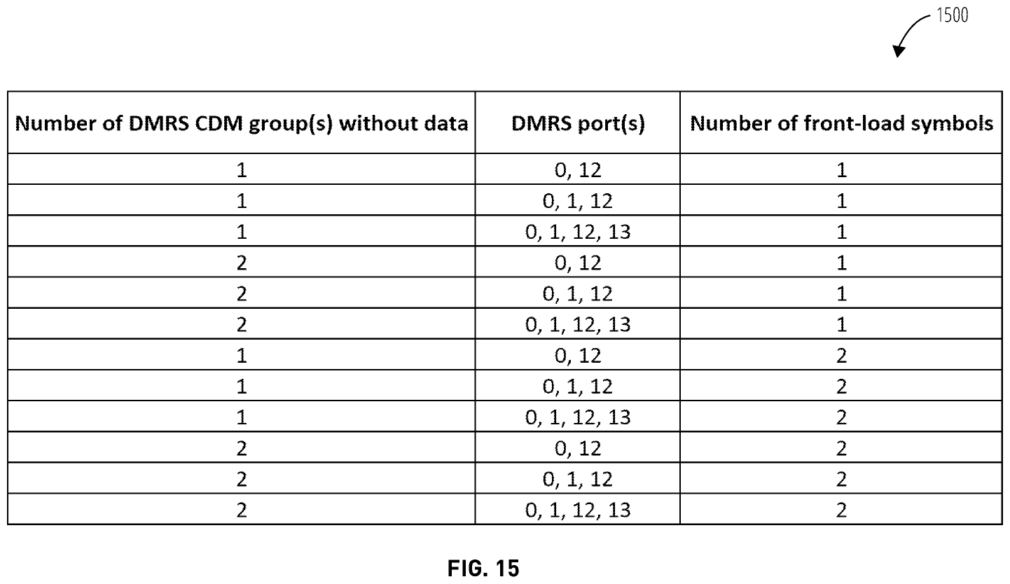

In some cases, for enhanced DMRS, for DMRS configuration Type 2 (dmrs-Type=2) and a maximum of two symbols per DMRS location (maxLength=2), a mixture of legacy and enhanced DMRS ports may be used. For example, in addition to an existing table for antenna port(s) in such cases as specified in NR systems in TS 38.212, Table 7.3.1.2.2-4, new entries may be added. For example, FIG. 15 illustrates a table 1500 having entries that may be used in the case of DMRS configuration Type 2 (dmrs-Type=2) and a maximum of two symbols per DMRS location (maxLength=2), according to embodiments herein. The UE may use table 1500 to determine the DMRS ports.

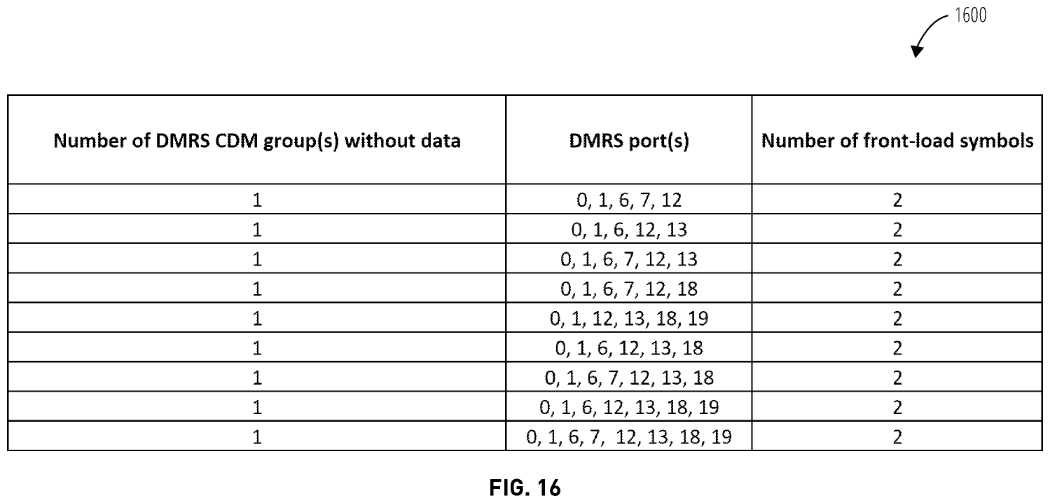

In some cases, for enhanced DMRS, for DMRS configuration Type 2 (dmrs-Type=2) and a maximum of two symbols per DMRS location (maxLength=2), combinations for the use of one CDM group and two front load symbols may be added to support the use of more than four layers. For example, entries for antenna port(s) as specified in NR systems in TS 38.212, Table 7.3.1.2.2-4 may be added upon to provide support for such cases. For example, FIG. 16 illustrates a table 1600 having entries that may be used in the case of DMRS configuration Type 2 (dmrs-Type=2) and a maximum of two symbols per DMRS location (maxLength=2) and where one CDM group and two front load symbols are used in order to support the use of more than four layers, according to embodiments herein. The UE may use table 1600 to determine the DMRS ports.

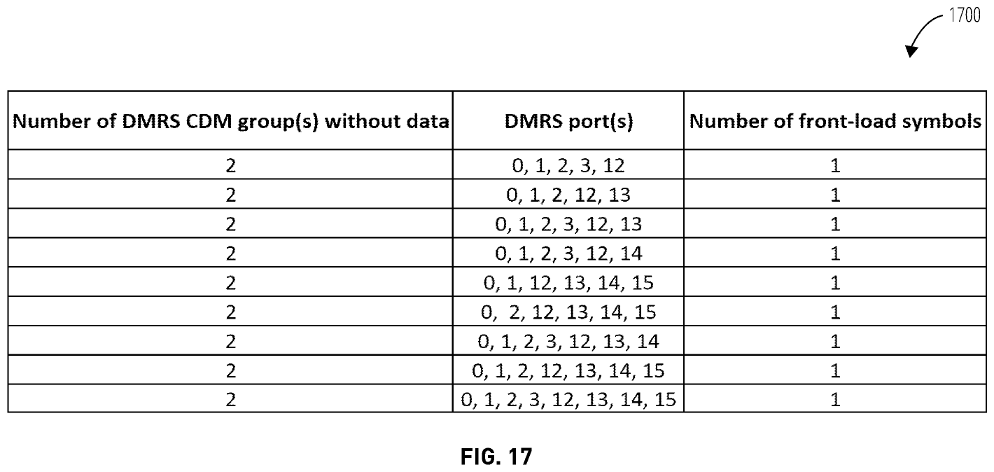

In some cases, for enhanced DMRS, with DMRS configuration Type 2 (dmrs-Type=2) and a maximum of two symbols per DMRS location (maxLength=2), combinations for the use of two CDM groups and one front load symbol may be added to support the use of more than four layers. For example, entries for antenna port(s) as specified in NR systems in TS 38.212, Table 7.3.1.2.2-4 may be added upon to provide support for such cases. For example, FIG. 17 illustrates a table 1700 having entries that may be used in the case of DMRS configuration Type 2 (dmrs-Type=2) and a maximum of two symbols per DMRS location (maxLength=2) and where two CDM groups and one front load symbol are used in order to support the use of more than four layers, according to embodiments herein. The UE may use table 1700 to determine the DMRS ports.

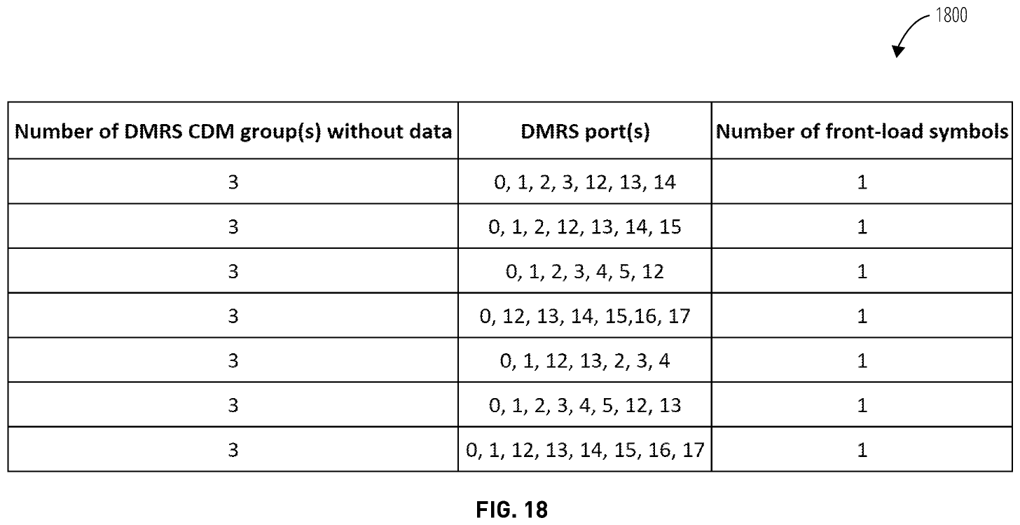

In some cases, for enhanced DMRS, with DMRS configuration Type 2 (dmrs-Type=2) and a maximum of two symbols per DMRS location (maxLength=2), combinations for the use of three CDM groups and one front load symbol may be added to support the use of more than six layers. For example, entries for antenna port(s) as specified in NR systems in TS 38.212, Table 7.3.1.2.2-4 may be added upon to provide support for such cases. For example, FIG. 18 illustrates a table 1800 having entries that may be used in the case of DMRS configuration Type 2 (dmrs-Type=2) and a maximum of two symbols per DMRS location (maxLength=2) and where three CDM groups and one front load symbol are used in order to support the use of more than six layers, according to embodiments herein. The UE may use table 1800 to determine the DMRS ports.

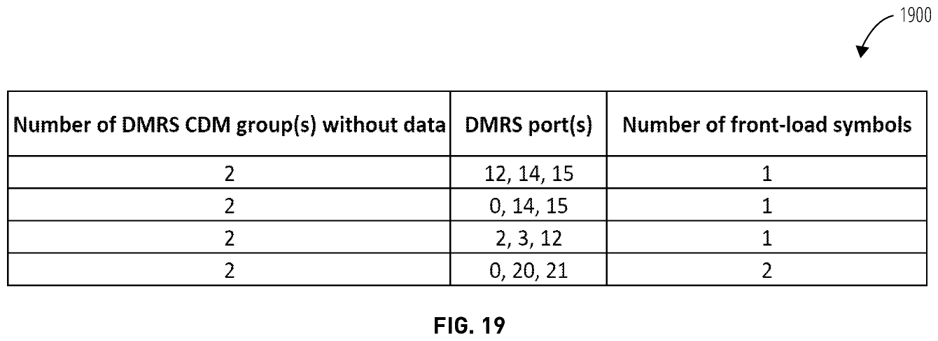

In some cases, for enhanced DMRS, with DMRS configuration Type 2 (dmrs-Type=2) and a maximum of two symbols per DMRS location (maxLength=2), for cases corresponding to an {0, 2, 3} antenna ports indication, additional ports may be specified. For example, with respect to an existing table for antenna port(s) in such cases as specified in NR systems in TS 38.212, Table 7.3.1.2.2-4A, new entries may be added to facilitate the use of new ports in such cases. For example, FIG. 19 illustrates a table 1900 having entries that may be used in the case of DMRS configuration Type 2 (dmrs-Type=2) and a maximum of two symbols per DMRS location (maxLength=2) and corresponding to an {0, 2, 3} antenna ports indication, according to embodiments herein.

The UE may use table 1900 to determine the DMRS ports.

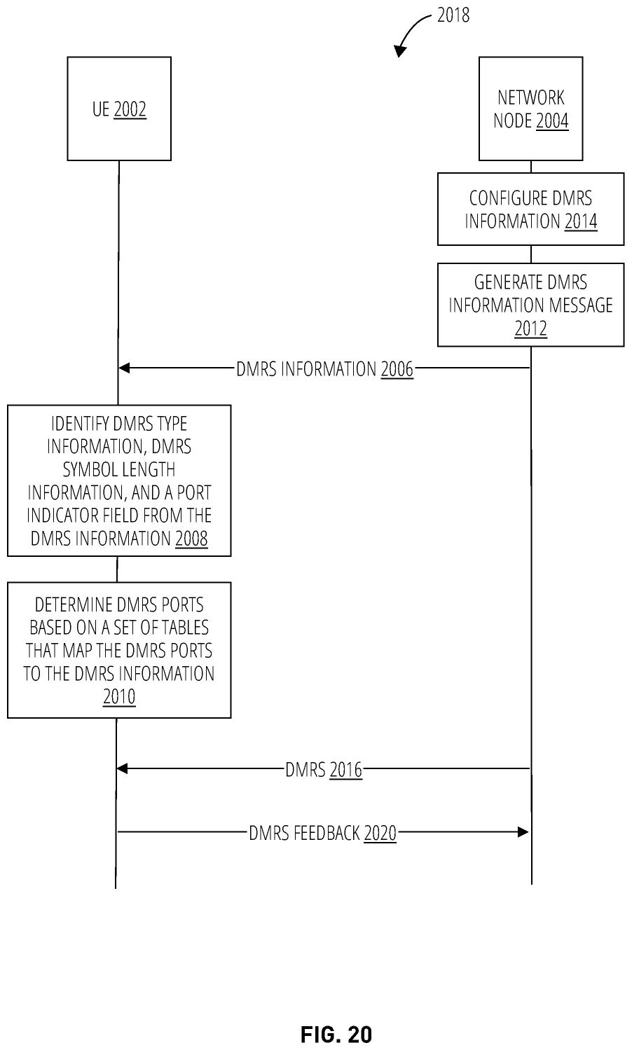

FIG. 20 illustrates an example signal flow diagram 2018 for determining DMRS ports in accordance with some embodiments. As shown, the network node 2004 may configure 2014 DMRS information. The DMRS information may include DMRS type (e.g., Type 1 or Type 2), DMRS symbol length information (e.g., maxLength=1 or maxLength=2), the number of DMRS CDM group(s) without data, FD-OCC length (e.g., FD-OCC length 4), an antenna ports indication, etc.

The network node 2004 may generate 2012 a DMRS information message with the DMRS configuration information. In some embodiments, the DMRS information 2006 may be sent via downlink control information (DCI) to a UE 2002. The UE may identify 2008 DMRS type information, DMRS symbol length information, the FD-OCC length, the antenna ports indication from the DMRS information. The UE may determine 2010 DMRS ports based on a set of tables that map the DMRS ports to the DMRS information.

For example, the UE 2002 may store the tables shown in FIGS. 1-19 and based on the DMRS parameters, the UE 2002 may determine 2010 the DMRS ports. The UE 2002 may interpret the tables based on the DMRS information. The UE 2002 may remain adaptive to changes in the network configuration. If the network node 2004 signals a change in the DMRS configuration, the UE 2002 refers back to the tables to re-determine the applicable DMRS ports and adjust its processing accordingly.

The UE 2002 may receive the DMRS 2016 from the network node 2004 over the DMRS ports. The UE 2002 may send DMRS feedback 2020 to the network node 2004. DMRS may be used for channel estimation to improve robustness, reliability, and efficiency of wireless communication systems.

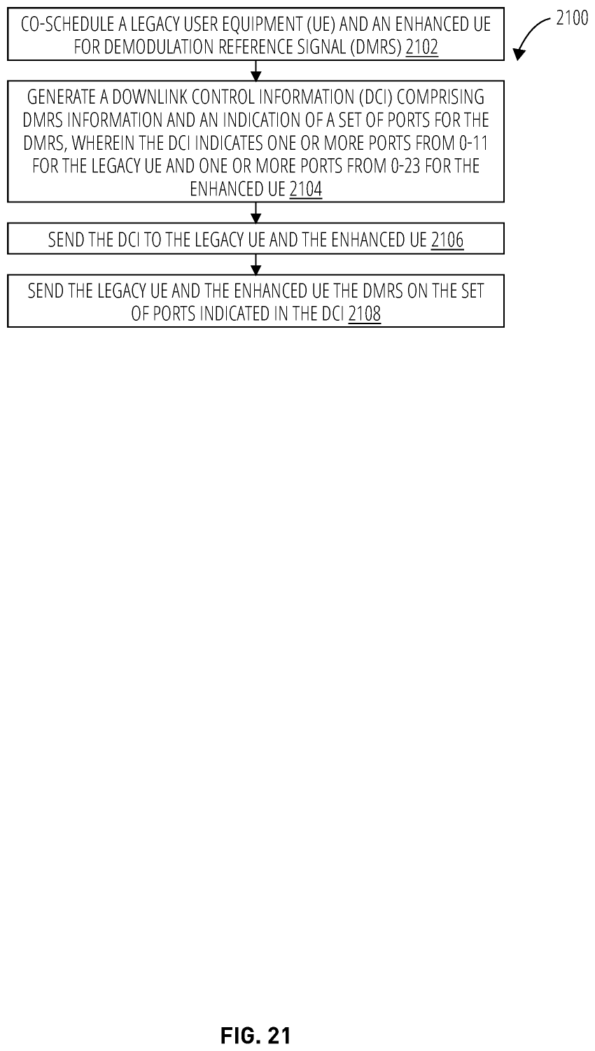

FIG. 21 illustrates a method 2100 performed by a network node in accordance with some embodiments. The method 2100 may facilitate MU-MIMO scheduling. The method 2100 includes co-scheduling 2102 a legacy UE and an enhanced UE for DMRS. The method 2100 further includes generating 2104 a DCI comprising DMRS information and an indication of a set of ports for the DMRS, wherein the DCI indicates one or more ports from 0-11 for the legacy UE and one or more ports from 0-23 for the enhanced UE. The method 2100 further includes sending 2106 the DCI to the legacy UE and the enhanced UE. The method 2100 further includes sending 2108 the legacy UE and the enhanced UE the DMRS on the set of ports indicated in the DCI.

In some embodiments, the indication comprises a row value of a table corresponding to the DMRS information, wherein a row corresponding to the row value indicates the DMRS is sent on ports 0, 1, and 12.

In some embodiments, the indication comprises a row value of a table corresponding to the DMRS information, wherein a row corresponding to the row value indicates the DMRS is sent on ports 0, 1, 12, and 13.

In some embodiments, the indication comprises a row value of a table corresponding to the DMRS information, wherein a row corresponding to the row value indicates the DMRS is sent on ports 0, 1, 2, 3, and 12.

In some embodiments, the legacy UE and the enhanced UE are co-scheduled with two CDM groups or three CDM groups.

In some embodiments, the DMRS information includes DMRS type, DMRS symbol length information, and a number of DMRS CDM group(s) without data.

In some embodiments, the DMRS type is Type 2, and the DMRS symbol length information indicates a maximum one symbol per DMRS location.

Embodiments contemplated herein include an apparatus comprising means to perform one or more elements of the method 2100. This apparatus may be, for example, an apparatus of a base station (such as a network device 2418 that is a base station, as described herein).

Embodiments contemplated herein include one or more non-transitory computer-readable media comprising instructions to cause an electronic device, upon execution of the instructions by one or more processors of the electronic device, to perform one or more elements of the method 2100. This non-transitory computer-readable media may be, for example, a memory of a base station (such as a memory 2422 of a network device 2418 that is a base station, as described herein).

Embodiments contemplated herein include an apparatus comprising logic, modules, or circuitry to perform one or more elements of the method 2100. This apparatus may be, for example, an apparatus of a base station (such as a network device 2418 that is a base station, as described herein).

Embodiments contemplated herein include an apparatus comprising: one or more processors and one or more computer-readable media comprising instructions that, when executed by the one or more processors, cause the one or more processors to perform one or more elements of the method 2100. This apparatus may be, for example, an apparatus of a base station (such as a network device 2418 that is a base station, as described herein).

Embodiments contemplated herein include a signal as described in or related to one or more elements of the method 2100.

Embodiments contemplated herein include a computer program or computer program product comprising instructions, wherein execution of the program by a processing element is to cause the processing element to carry out one or more elements of the method 2100. The processor may be a processor of a base station (such as a processor(s) 2420 of a network device 2418 that is a base station, as described herein). These instructions may be, for example, located in the processor and/or on a memory of the base station (such as a memory 2422 of a network device 2418 that is a base station, as described herein).

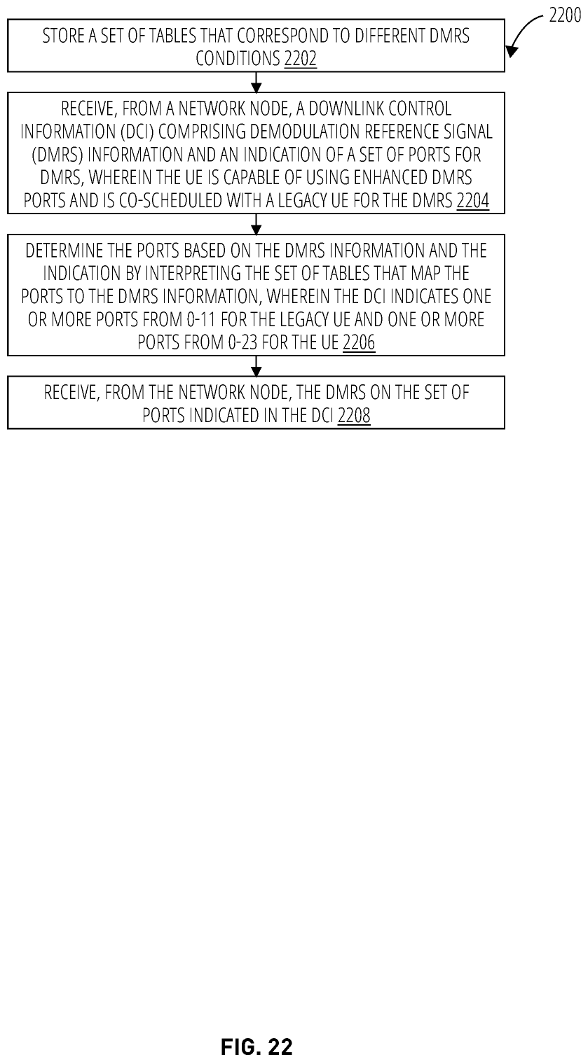

FIG. 22 illustrates a method 2200 performed by a UE in accordance with some embodiments. The method 2200 may facilitate MU-MIMO scheduling. The method 2200 includes storing 2202 a set of tables that correspond to different DMRS conditions. The method 2200 further includes receiving 2204, from a network node, a DCI comprising DMRS information and an indication of a set of ports for DMRS, wherein the UE is capable of using enhanced DMRS ports and is co-scheduled with a legacy UE for the DMRS. The method 2200 further includes determining 2206 the ports based on the DMRS information and the indication by interpreting the set of tables that map the ports to the DMRS information, wherein the DCI indicates one or more ports from 0-11 for the legacy UE and one or more ports from 0-23 for the UE. The method 2200 further includes receiving 2208, from the network node, the DMRS on the set of ports indicated in the DCI.

In some embodiments, the indication comprises a row value of a table from the set of tables corresponding to the DMRS information, wherein a row corresponding to the row value indicates the DMRS is sent on ports 0, 1, and 12.

In some embodiments, the indication comprises a row value of a table from the set of tables corresponding to the DMRS information, wherein a row corresponding to the row value indicates the DMRS is sent on ports 0, 1, 12, and 13.

In some embodiments, the indication comprises a row value of a table from the set of tables corresponding to the DMRS information, wherein a row corresponding to the row value indicates the DMRS is sent on ports 0, 1, 2, 3, and 12.

In some embodiments, the legacy UE and the UE are co-scheduled with two CDM groups or three CDM groups.

In some embodiments, the DMRS information includes DMRS type, DMRS symbol length information, and a number of DMRS CDM group(s) without data.

In some embodiments, the DMRS type is Type 2, and the DMRS symbol length information indicates a maximum one symbol per DMRS location.

Embodiments contemplated herein include an apparatus comprising means to perform one or more elements of the method 2200. This apparatus may be, for example, an apparatus of a UE (such as a wireless device 2402 that is a UE, as described herein).

Embodiments contemplated herein include one or more non-transitory computer-readable media comprising instructions to cause an electronic device, upon execution of the instructions by one or more processors of the electronic device, to perform one or more elements of the method 2200. This non-transitory computer-readable media may be, for example, a memory of a UE (such as a memory 2406 of a wireless device 2402 that is a UE, as described herein).

Embodiments contemplated herein include an apparatus comprising logic, modules, or circuitry to perform one or more elements of the method 2200. This apparatus may be, for example, an apparatus of a UE (such as a wireless device 2402 that is a UE, as described herein).

Embodiments contemplated herein include an apparatus comprising: one or more processors and one or more computer-readable media comprising instructions that, when executed by the one or more processors, cause the one or more processors to perform one or more elements of the method 2200. This apparatus may be, for example, an apparatus of a UE (such as a wireless device 2402 that is a UE, as described herein).

Embodiments contemplated herein include a signal as described in or related to one or more elements of the method 2200.

Embodiments contemplated herein include a computer program or computer program product comprising instructions, wherein execution of the program by a processor is to cause the processor to carry out one or more elements of the method 2200. The processor may be a processor of a UE (such as a processor(s) 2404 of a wireless device 2402 that is a UE, as described herein). These instructions may be, for example, located in the processor and/or on a memory of the UE (such as a memory 2406 of a wireless device 2402 that is a UE, as described herein).

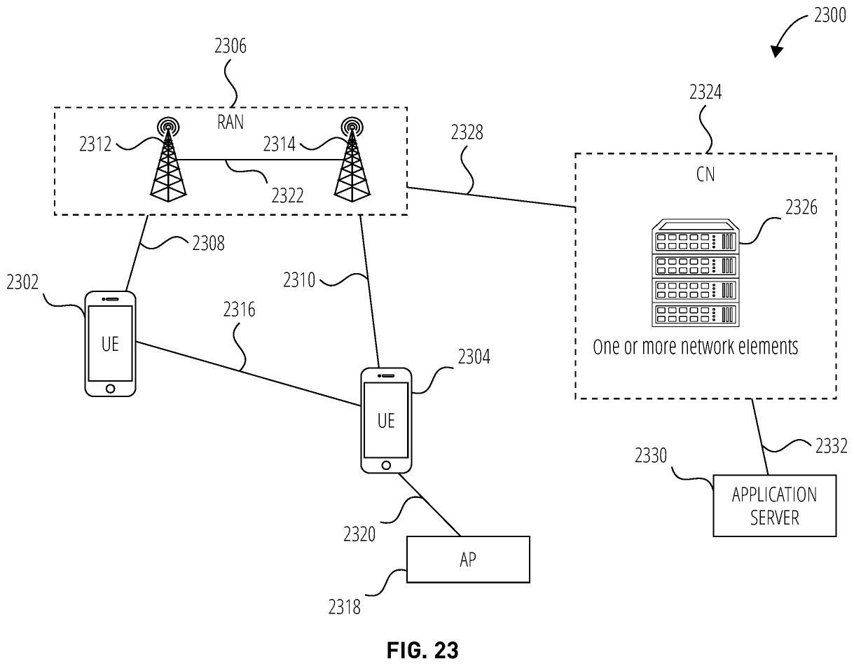

FIG. 23 illustrates an example architecture of a wireless communication system 2300, according to embodiments disclosed herein. The following description is provided for an example wireless communication system 2300 that operates in conjunction with the LTE system standards and/or 5G or NR system standards as provided by 3GPP technical specifications.

As shown by FIG. 23, the wireless communication system 2300 includes UE 2302 and UE 2304 (although any number of UEs may be used). In this example, the UE 2302 and the UE 2304 are illustrated as smartphones (e.g., handheld touchscreen mobile computing devices connectable to one or more cellular networks), but may also comprise any mobile or non-mobile computing device configured for wireless communication.

The UE 2302 and UE 2304 may be configured to communicatively couple with a RAN 2306. In embodiments, the RAN 2306 may be NG-RAN, E-UTRAN, etc. The UE 2302 and UE 2304 utilize connections (or channels) (shown as connection 2308 and connection 2310, respectively) with the RAN 2306, each of which comprises a physical communications interface. The RAN 2306 can include one or more base stations (such as base station 2312 and base station 2314) that enable the connection 2308 and connection 2310.

In this example, the connection 2308 and connection 2310 are air interfaces to enable such communicative coupling, and may be consistent with RAT(s) used by the RAN 2306, such as, for example, an LTE and/or NR.

In some embodiments, the UE 2302 and UE 2304 may also directly exchange communication data via a sidelink interface 2316. The UE 2304 is shown to be configured to access an access point (shown as AP 2318) via connection 2320. By way of example, the connection 2320 can comprise a local wireless connection, such as a connection consistent with any IEEE 802.11 protocol, wherein the AP 2318 may comprise a Wi-Fi® router. In this example, the AP 2318 may be connected to another network (for example, the Internet) without going through a CN 2324.

In embodiments, the UE 2302 and UE 2304 can be configured to communicate using orthogonal frequency division multiplexing (OFDM) communication signals with each other or with the base station 2312 and/or the base station 2314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 2312 or base station 2314 may be implemented as one or more software entities running on server computers as part of a virtual network. In addition, or in other embodiments, the base station 2312 or base station 2314 may be configured to communicate with one another via interface 2322. In embodiments where the wireless communication system 2300 is an LTE system (e.g., when the CN 2324 is an EPC), the interface 2322 may be an X2 interface. The X2 interface may be defined between two or more base stations (e.g., two or more eNBs and the like) that connect to an EPC, and/or between two eNBs connecting to the EPC. In embodiments where the wireless communication system 2300 is an NR system (e.g., when CN 2324 is a 5GC), the interface 2322 may be an Xn interface. The Xn interface is defined between two or more base stations (e.g., two or more gNBs and the like) that connect to 5GC, between a base station 2312 (e.g., a gNB) connecting to 5GC and an eNB, and/or between two eNBs connecting to 5GC (e.g., CN 2324).

The RAN 2306 is shown to be communicatively coupled to the CN 2324. The CN 2324 may comprise one or more network elements 2326, which are configured to offer various data and telecommunications services to customers/subscribers (e.g., users of UE 2302 and UE 2304) who are connected to the CN 2324 via the RAN 2306. The components of the CN 2324 may be implemented in one physical device or separate physical devices including components to read and execute instructions from a machine-readable or computer-readable medium (e.g., a non-transitory machine-readable storage medium).

In embodiments, the CN 2324 may be an EPC, and the RAN 2306 may be connected with the CN 2324 via an S1 interface 2328. In embodiments, the S1 interface 2328 may be split into two parts, an S1 user plane (S1-U) interface, which carries traffic data between the base station 2312 or base station 2314 and a serving gateway (S-GW), and the S1-MME interface, which is a signaling interface between the base station 2312 or base station 2314 and mobility management entities (MMEs).

In embodiments, the CN 2324 may be a 5GC, and the RAN 2306 may be connected with the CN 2324 via an NG interface 2328. In embodiments, the NG interface 2328 may be split into two parts, an NG user plane (NG-U) interface, which carries traffic data between the base station 2312 or base station 2314 and a user plane function (UPF), and the S1 control plane (NG-C) interface, which is a signaling interface between the base station 2312 or base station 2314 and access and mobility management functions (AMFs).

Generally, an application server 2330 may be an element offering applications that use internet protocol (IP) bearer resources with the CN 2324 (e.g., packet switched data services). The application server 2330 can also be configured to support one or more communication services (e.g., VoIP sessions, group communication sessions, etc.) for the UE 2302 and UE 2304 via the CN 2324. The application server 2330 may communicate with the CN 2324 through an IP communications interface 2332.

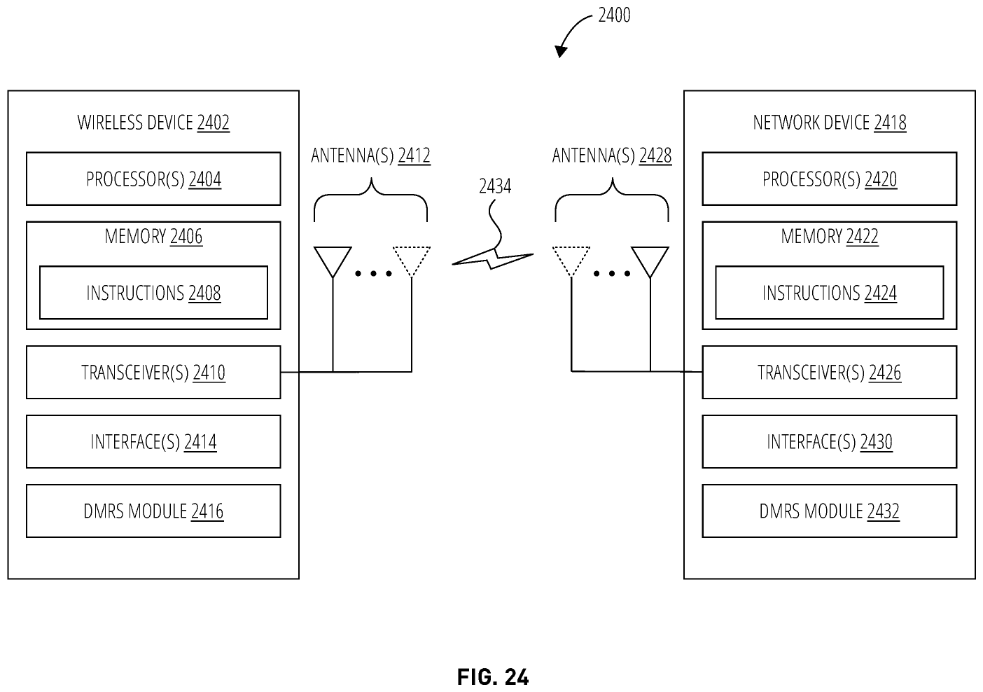

FIG. 24 illustrates a system 2400 for performing signaling 2434 between a wireless device 2402 and a network device 2418, according to embodiments disclosed herein. The system 2400 may be a portion of a wireless communications system as herein described. The wireless device 2402 may be, for example, a UE of a wireless communication system. The network device 2418 may be, for example, a base station (e.g., an eNB or a gNB) of a wireless communication system.

The wireless device 2402 may include one or more processor(s) 2404. The processor(s) 2404 may execute instructions such that various operations of the wireless device 2402 are performed, as described herein. The processor(s) 2404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 2402 may include a memory 2406. The memory 2406 may be a non-transitory computer-readable storage medium that stores instructions 2408 (which may include, for example, the instructions being executed by the processor(s) 2404). The instructions 2408 may also be referred to as program code or a computer program. The memory 2406 may also store data used by, and results computed by, the processor(s) 2404.

The wireless device 2402 may include one or more transceiver(s) 2410 that may include radio frequency (RF) transmitter circuitry and/or receiver circuitry that use the antenna(s) 2412 of the wireless device 2402 to facilitate signaling (e.g., the signaling 2434) to and/or from the wireless device 2402 with other devices (e.g., the network device 2418) according to corresponding RATs.

The wireless device 2402 may include one or more antenna(s) 2412 (e.g., one, two, four, or more). For embodiments with multiple antenna(s) 2412, the wireless device 2402 may leverage the spatial diversity of such multiple antenna(s) 2412 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 2402 may be accomplished according to precoding (or digital beamforming) that is applied at the wireless device 2402 that multiplexes the data streams across the antenna(s) 2412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 2402 may implement analog beamforming techniques, whereby phases of the signals sent by the antenna(s) 2412 are relatively adjusted such that the (joint) transmission of the antenna(s) 2412 can be directed (this is sometimes referred to as beam steering).

The wireless device 2402 may include one or more interface(s) 2414. The interface(s) 2414 may be used to provide input to or output from the wireless device 2402. For example, a wireless device 2402 that is a UE may include interface(s) 2414 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 2410/antenna(s) 2412 already described) that allow for communication between the UE and other devices and may operate according to known protocols (e.g., Wi-Fi®, Bluetooth®, and the like).

The wireless device 2402 may include a DMRS module 2416. The DMRS module 2416 may be implemented via hardware, software, or combinations thereof. For example, the DMRS module 2416 may be implemented as a processor, circuit, and/or instructions 2408 stored in the memory 2406 and executed by the processor(s) 2404. In some examples, the DMRS module 2416 may be integrated within the processor(s) 2404 and/or the transceiver(s) 2410. For example, the DMRS module 2416 may be implemented by a combination of software components (e.g., executed by a DSP or a general processor) and hardware components (e.g., logic gates and circuitry) within the processor(s) 2404 or the transceiver(s) 2410.

The DMRS module 2416 may be used for various aspects of the present disclosure, for example, aspects of FIG. 1 through FIG. 19. The DMRS module 2416 is configured to enable the UE to utilize DMRSs (e.g., enhanced DMRSs) in one or more of the manners that has been described herein.

The network device 2418 may include one or more processor(s) 2420. The processor(s) 2420 may execute instructions such that various operations of the network device 2418 are performed, as described herein. The processor(s) 2420 may include one or more baseband processors implemented using, for example, a CPU, a DSP, an ASIC, a controller, an FPGA device, another hardware device, a firmware device, or any combination thereof configured to perform the operations described herein.

The network device 2418 may include a memory 2422. The memory 2422 may be a non-transitory computer-readable storage medium that stores instructions 2424 (which may include, for example, the instructions being executed by the processor(s) 2420). The instructions 2424 may also be referred to as program code or a computer program. The memory 2422 may also store data used by, and results computed by, the processor(s) 2420.

The network device 2418 may include one or more transceiver(s) 2426 that may include RF transmitter circuitry and/or receiver circuitry that use the antenna(s) 2428 of the network device 2418 to facilitate signaling (e.g., the signaling 2434) to and/or from the network device 2418 with other devices (e.g., the wireless device 2402) according to corresponding RATs.

The network device 2418 may include one or more antenna(s) 2428 (e.g., one, two, four, or more). In embodiments having multiple antenna(s) 2428, the network device 2418 may perform MIMO, digital beamforming, analog beamforming, beam steering, etc., as has been described.

The network device 2418 may include one or more interface(s) 2430. The interface(s) 2430 may be used to provide input to or output from the network device 2418. For example, a network device 2418 that is a base station may include interface(s) 2430 made up of transmitters, receivers, and other circuitry (e.g., other than the transceiver(s) 2426/antenna(s) 2428 already described) that enables the base station to communicate with other equipment in a core network, and/or that enables the base station to communicate with external networks, computers, databases, and the like for purposes of operations, administration, and maintenance of the base station or other equipment operably connected thereto.

The network device 2418 may include a DMRS module 2432. The DMRS module 2432 may be implemented via hardware, software, or combinations thereof. For example, the DMRS module 2432 may be implemented as a processor, circuit, and/or instructions 2424 stored in the memory 2422 and executed by the processor(s) 2420. In some examples, the DMRS module 2432 may be integrated within the processor(s) 2420 and/or the transceiver(s) 2426. For example, the DMRS module 2432 may be implemented by a combination of software components (e.g., executed by a DSP or a general processor) and hardware components (e.g., logic gates and circuitry) within the processor(s) 2420 or the transceiver(s) 2426.

The DMRS module 2432 may be used for various aspects of the present disclosure, for example, aspects of FIG. 1 through FIG. 19. The DMRS module 2432 is configured to enable the network (e.g., the network device 2418, which may include a base station) to utilize DMRSs (e.g., enhanced DMRSs) in one or more of the manners that has been described herein.

Embodiments contemplated herein include an apparatus comprising means to perform one or more elements of one or more methods discussed herein. This apparatus may be, for example, an apparatus of a UE (such as a wireless device 2402 that is a UE, as described herein).

Embodiments contemplated herein include one or more non-transitory computer-readable media comprising instructions to cause an electronic device, upon execution of the instructions by one or more processors of the electronic device, to perform one or more elements of one or more methods discussed herein. This non-transitory computer-readable media may be, for example, a memory of a UE (such as a memory 2406 of a wireless device 2402 that is a UE, as described herein).

Embodiments contemplated herein include an apparatus comprising logic, modules, or circuitry to perform one or more elements of one or more methods discussed herein. This apparatus may be, for example, an apparatus of a UE (such as a wireless device 2402 that is a UE, as described herein).

Embodiments contemplated herein include an apparatus comprising: one or more processors and one or more computer-readable media comprising instructions that, when executed by the one or more processors, cause the one or more processors to perform one or more elements of one or more methods discussed herein. This apparatus may be, for example, an apparatus of a UE (such as a wireless device 2402 that is a UE, as described herein).

Embodiments contemplated herein include a signal as described in or related to one or more elements of one or more methods discussed herein.

Embodiments contemplated herein include a computer program or computer program product comprising instructions, wherein execution of the program by a processor is to cause the processor to carry out one or more elements of one or more methods discussed herein. The processor may be a processor of a UE (such as a processor(s) 2404 of a wireless device 2402 that is a UE, as described herein). These instructions may be, for example, located in the processor and/or on a memory of the UE (such as a memory 2406 of a wireless device 2402 that is a UE, as described herein).

Embodiments contemplated herein include an apparatus comprising means to perform one or more elements of one or more methods discussed herein. This apparatus may be, for example, an apparatus of a base station (such as a network device 2418 that is a base station, as described herein).

Embodiments contemplated herein include one or more non-transitory computer-readable media comprising instructions to cause an electronic device, upon execution of the instructions by one or more processors of the electronic device, to perform one or more elements of one or more methods discussed herein. This non-transitory computer-readable media may be, for example, a memory of a base station (such as a memory 2422 of a network device 2418 that is a base station, as described herein).

Embodiments contemplated herein include an apparatus comprising logic, modules, or circuitry to perform one or more elements of one or more methods discussed herein. This apparatus may be, for example, an apparatus of a base station (such as a network device 2418 that is a base station, as described herein).

Embodiments contemplated herein include an apparatus comprising: one or more processors and one or more computer-readable media comprising instructions that, when executed by the one or more processors, cause the one or more processors to perform one or more elements of one or more methods discussed herein. This apparatus may be, for example, an apparatus of a base station (such as a network device 2418 that is a base station, as described herein).

Embodiments contemplated herein include a signal as described in or related to one or more elements of one or more methods discussed herein.

Embodiments contemplated herein include a computer program or computer program product comprising instructions, wherein execution of the program by a processing element is to cause the processing element to carry out one or more elements of one or more methods discussed herein. The processor may be a processor of a base station (such as a processor(s) 2420 of a network device 2418 that is a base station, as described herein). These instructions may be, for example, located in the processor and/or on a memory of the base station (such as a memory 2422 of a network device 2418 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method performed by a network node, the method comprising:
co-scheduling a legacy user equipment (UE) and an enhanced UE for demodulation reference signal (DMRS);
generating a downlink control information (DCI) comprising DMRS information and an indication of a set of ports for the DMRS, wherein the DCI indicates one or more ports from 0-11 for the legacy UE and one or more ports from 0-23 for the enhanced UE;
sending the DCI to the legacy UE and the enhanced UE; and
sending the legacy UE and the enhanced UE the DMRS on the set of ports indicated in the DCI.

2. The method of claim 1, wherein the indication comprises a row value of a table corresponding to the DMRS information, wherein a row corresponding to the row value indicates the DMRS is sent on ports 0, 1, and 12.

3. The method of claim 1, wherein the indication comprises a row value of a table corresponding to the DMRS information, wherein a row corresponding to the row value indicates the DMRS is sent on ports 0, 1, 12, and 13.

4. The method of claim 1, wherein the indication comprises a row value of a table corresponding to the DMRS information, wherein a row corresponding to the row value indicates the DMRS is sent on ports 0, 1, 2, 3, and 12.

5. The method of claim 1, wherein the legacy UE and the enhanced UE are co-scheduled with two CDM groups or three CDM groups.

6. The method of claim 1, wherein the DMRS information includes DMRS type, DMRS symbol length information, and a number of DMRS CDM group(s) without data.

7. The method of claim 6, wherein the DMRS type is Type 2, and the DMRS symbol length information indicates a maximum one symbol per DMRS location.

8. A method performed by a user equipment (UE), the method comprising:
storing a set of tables that correspond to different demodulation reference signal (DMRS) conditions;
receiving, from a network node, a downlink control information (DCI) comprising DMRS information and an indication of a set of ports for DMRS, wherein the UE is capable of using enhanced DMRS ports and is co-scheduled with a legacy UE for the DMRS;
determining the ports based on the DMRS information and the indication by interpreting the set of tables that map the ports to the DMRS information, wherein the DCI indicates one or more ports from 0-11 for the legacy UE and one or more ports from 0-23 for the UE; and
receiving, from the network node, the DMRS on the set of ports indicated in the DCI.

9. The method of claim 8, wherein the indication comprises a row value of a table from the set of tables corresponding to the DMRS information, wherein a row corresponding to the row value indicates the DMRS is sent on ports 0, 1, and 12.

10. The method of claim 8, wherein the indication comprises a row value of a table from the set of tables corresponding to the DMRS information, wherein a row corresponding to the row value indicates the DMRS is sent on ports 0, 1, 12, and 13.

11. The method of claim 8, wherein the indication comprises a row value of a table from the set of tables corresponding to the DMRS information, wherein a row corresponding to the row value indicates the DMRS is sent on ports 0, 1, 2, 3, and 12.

12. The method of claim 8, wherein the legacy UE and the UE are co-scheduled with two CDM groups or three CDM groups.

13. The method of claim 8, wherein the DMRS information includes DMRS type, DMRS symbol length information, and a number of DMRS CDM group(s) without data.

14. The method of claim 13, wherein the DMRS type is Type 2, and the DMRS symbol length information indicates a maximum one symbol per DMRS location.

15. A network node apparatus comprising:
a processor; and
a memory storing instructions that, when executed by the processor, configure the apparatus to:
co-schedule a legacy user equipment (UE) and an enhanced UE for demodulation reference signal (DMRS);
generate a downlink control information (DCI) comprising DMRS information and an indication of a set of ports for the DMRS, wherein the DCI indicates one or more ports from 0-11 for the legacy UE and one or more ports from 0-23 for the enhanced UE;
send the DCI to the legacy UE and the enhanced UE; and
send the legacy UE and the enhanced UE the DMRS on the set of ports indicated in the DCI.

16. The network node apparatus of claim 15, wherein the indication comprises a row value of a table corresponding to the DMRS information, wherein a row corresponding to the row value indicates the DMRS is sent on ports 0, 1, and 12.

17. The network node apparatus of claim 15, wherein the indication comprises a row value of a table corresponding to the DMRS information, wherein a row corresponding to the row value indicates the DMRS is sent on ports 0, 1, 12, and 13.

18. The network node apparatus of claim 15, wherein the indication comprises a row value of a table corresponding to the DMRS information, wherein a row corresponding to the row value indicates the DMRS is sent on ports 0, 1, 2, 3, and 12.

19. The network node apparatus of claim 15, wherein the legacy UE and the enhanced UE are co-scheduled with two CDM groups or three CDM groups.

20. The network node apparatus of claim 15, wherein the DMRS information includes DMRS type, DMRS symbol length information, and a number of DMRS CDM group(s) without data.
